(19) United States
(12) Patent Application Publication
(10) Pub. No.: US 2025/0172180 A1
(43) Pub. Date: May 29, 2025

(54) ACTUATION DEVICE FOR A DISC BRAKE

(71) Applicant: BREMBO S.p.A., Curno (Bergamo) (IT)

(72) Inventors: Andrea CASADIO, Curno (Bergamo) (IT); Filippo CORNARA, Curno (Bergamo) (IT)

(73) Assignee: BREMBO S.p.A., Curno (Bergamo) (IT)

(21) Appl. No.: 18/843,327

(22) PCT Filed: Mar. 2, 2023
(86) PCT No.: PCT/IB2023/051928

§ 371 Date: Sep. 3, 2024

(30) Foreign Application Priority Data
Mar. 3, 2022 (IT) 102022000003968

(51) Int. Cl. F16D 55/226; F16D 65/18

(52) U.S. Cl. CPC F16D 55/226; F16D 65/183

(57) ABSTRACT

An actuation device for a brake disc has a recirculating ball screw-nut screw assembly and a thrust bearing. The recirculating ball screw-nut screw assembly has a threaded shaft and a nut screw screwed onto the threaded shaft. The threaded shaft and the nut screw extend in direction of an actuation axis. The threaded shaft extends between a front end and a rear end of the threaded shaft. The nut screw receives a torque generatable by a gearmotor. A rotation of the nut screw with respect to the threaded shaft results in a translation of the threaded shaft with respect to the nut screw in the direction of the actuation axis. The thrust bearing provides a reaction rest for the nut screw in the direction of the actuation axis. The thrust bearing is positioned within an extension of the threaded shaft between the front and rear ends of the threaded shaft.

### FIELD OF THE INVENTION

The present invention relates to an actuation device for a disc brake, in particular for an electromechanical disc brake, as well as to a disc brake provided with such an actuation device.

### BACKGROUND ART

Actuation devices for disc brakes are known, comprising a gearmotor associated with a recirculating ball screw-nut screw assembly, formed by a threaded shaft and a nut screw, which converts the torque generated by the gearmotor into a braking force directed against the disc brake pads.

It is known to apply the torque generated by the gearmotor to the threaded shaft so as to induce a translation of the nut screw in the direction of the disc brake pads and thus generate the braking force.

These known actuation devices are installed directly on the axial joint of the vehicle, thus being part of the unsprung weight of the vehicle.

Such a configuration implies several technical issues, including a large axial dimension at the axial joint of the vehicle, and an undesirably high increase in the unsprung weight of the vehicle.

The large axial dimension, i.e., in the direction of the braking force application, is caused by the need to allocate, at the rear end of the threaded shaft, a thrust bearing and the system for transmitting the torque generated by the gearmotor.

A large axial dimension hinders the design of the wheel joint, which thus limits the maximum steering of the vehicle.

Furthermore, heavy weights negatively affect the vehicle dynamics and cause higher energy consumption and CO2 emissions.

An actuation device of this known type is described in WO2021229375A1, for example.

### SOLUTION

It is the object of the present invention to provide an actuation device for a disc brake having features such as to avoid at least some of the drawbacks noticed in the prior art.

It is a particular object of the present invention to provide an actuation device for a disc brake having small axial dimensions and weight, the efficiency being the same or improved.

These and other objects are achieved by an actuation device for a disc brake according to claim 1.

The dependent claims relate to preferred and advantageous embodiments of the present invention.

### DRAWINGS

In order to better understand the invention and appreciate the advantages thereof, some non-limiting exemplary embodiments thereof will be described below with reference to the accompanying drawings, in which:

FIG. 1 is a side view of a caliper for a disc brake, along an axial section, according to an embodiment of the invention;

FIG. 2 is a top view of a caliper for a disc brake, along an axial section, according to an embodiment of the invention;

FIG. 3 is a front perspective view of an actuation device for a disc brake according to an embodiment of the invention;

FIG. 4 is a rear perspective view of the actuation device for a disc brake depicted in FIG. 3;

FIG. 5 is a side view of the actuation device for a disc brake depicted in FIG. 3;

FIG. 6 is an axial section view of the actuation device for a disc brake depicted in FIG. 5;

FIG. 7 is an exploded view of the actuation device for a disc brake depicted in FIG. 3;

FIG. 8 is an exploded view of the actuation device depicted in FIG. 4;

FIG. 9A is a front perspective view of an actuation device for a disc brake according to an embodiment of the invention;

FIG. 9B is a rear perspective view of the actuation device for a disc brake depicted in FIG. 9A;

FIG. 9C is an axial section view of the actuation device depicted in FIG. 9A;

FIG. 10A is a front perspective view of an actuation device for a disc brake according to an embodiment of the invention;

FIG. 10B is a rear perspective view of the actuation device for a disc brake depicted in FIG. 10A;

FIG. 10C is an axial section view of the actuation device depicted in FIG. 10A;

FIG. 11 is an axial section view of an actuation device for a disc brake according to an embodiment of the invention;

FIG. 12 is an axial section view of an actuation device for a disc brake according to a further embodiment of the invention;

FIG. 13 is a front exploded view of an actuation device for a disc brake according to an embodiment of the invention;

FIG. 14 is a rear exploded view of the actuation device in FIG. 13.

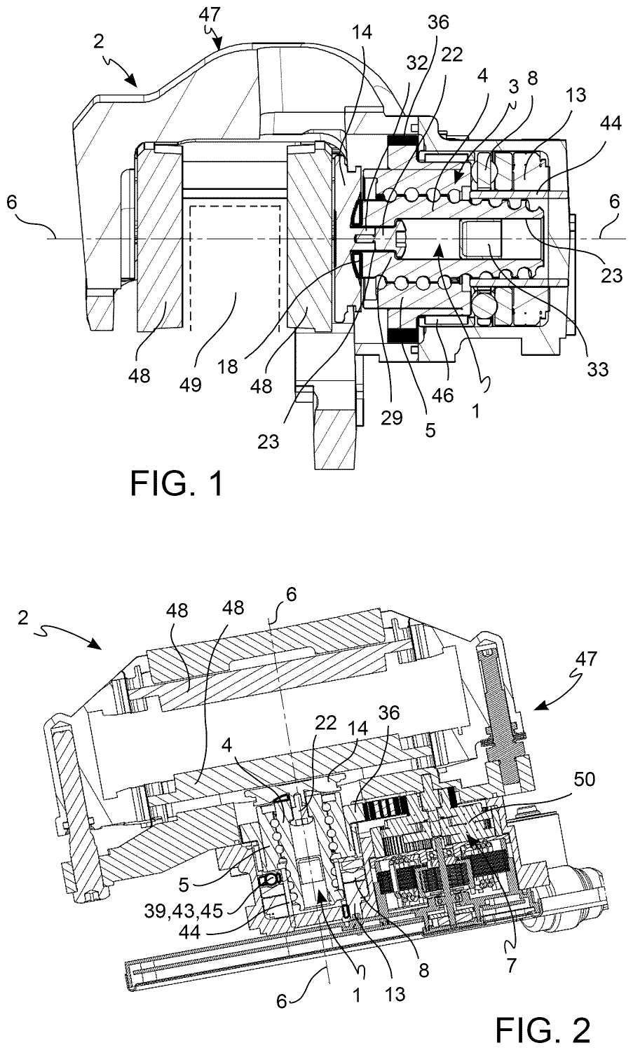

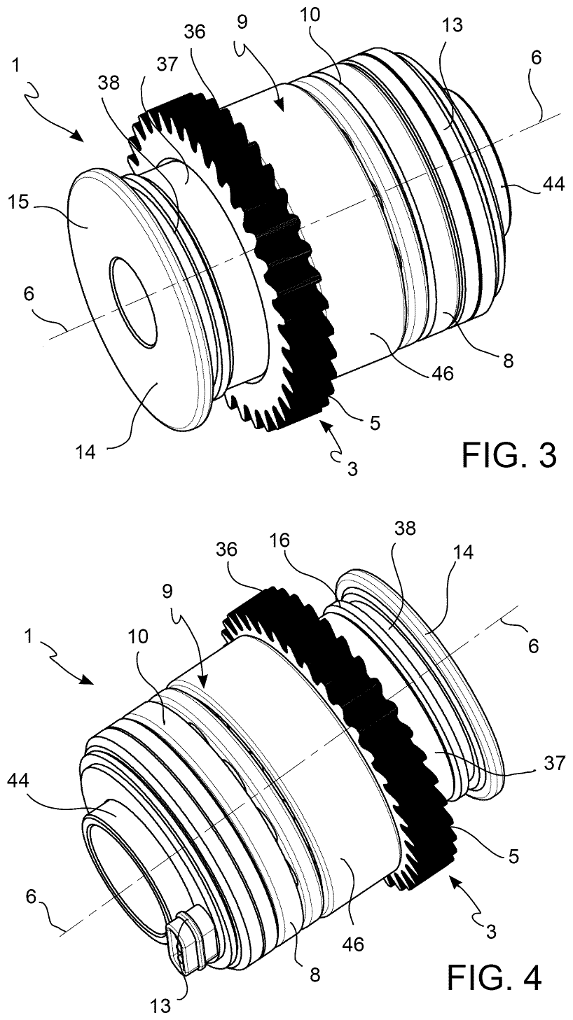

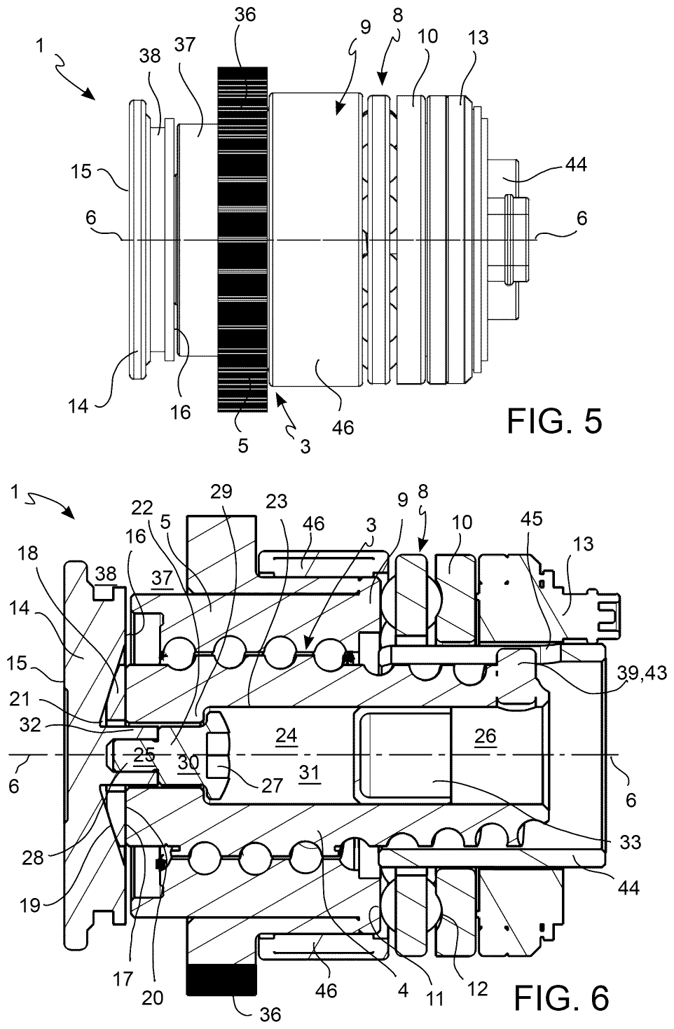

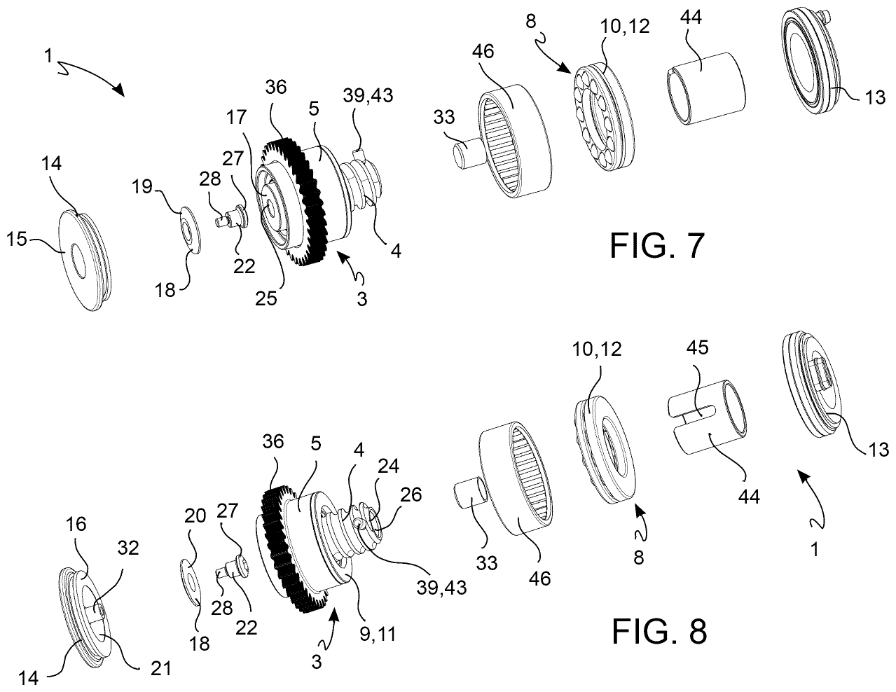

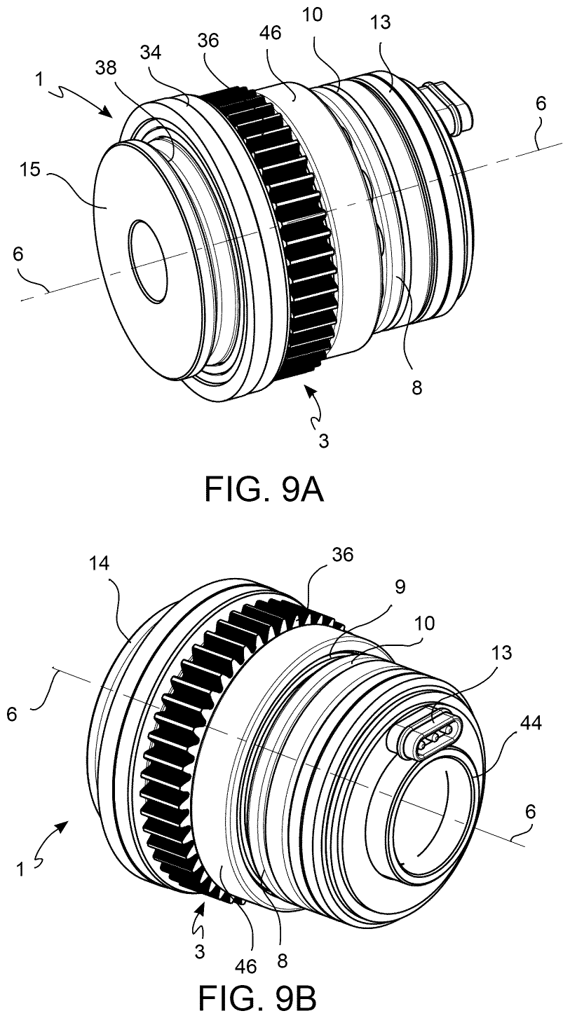

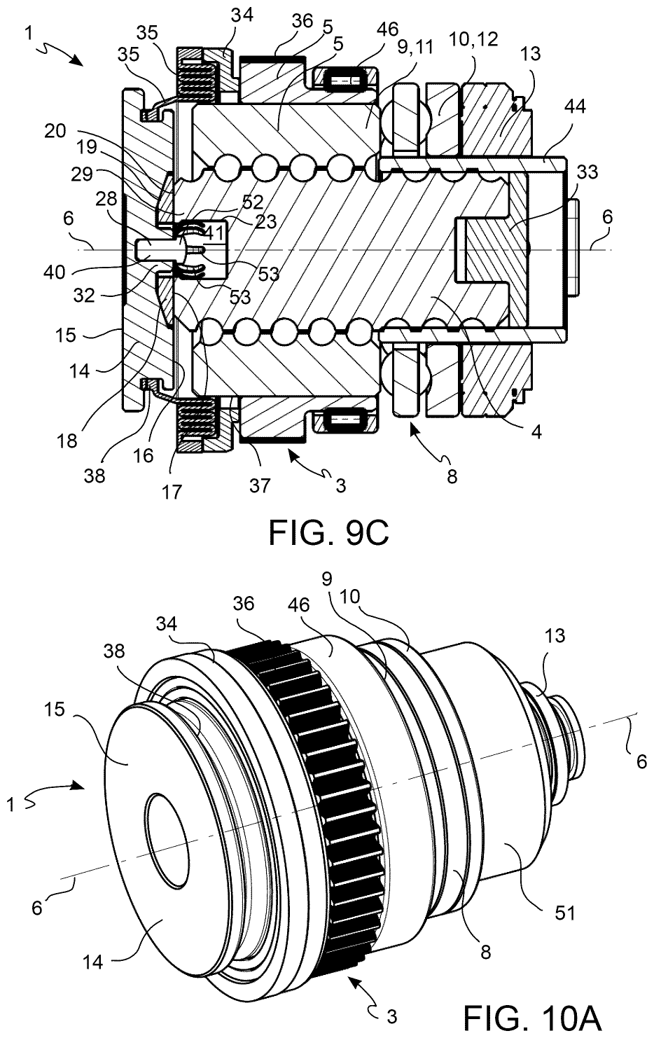

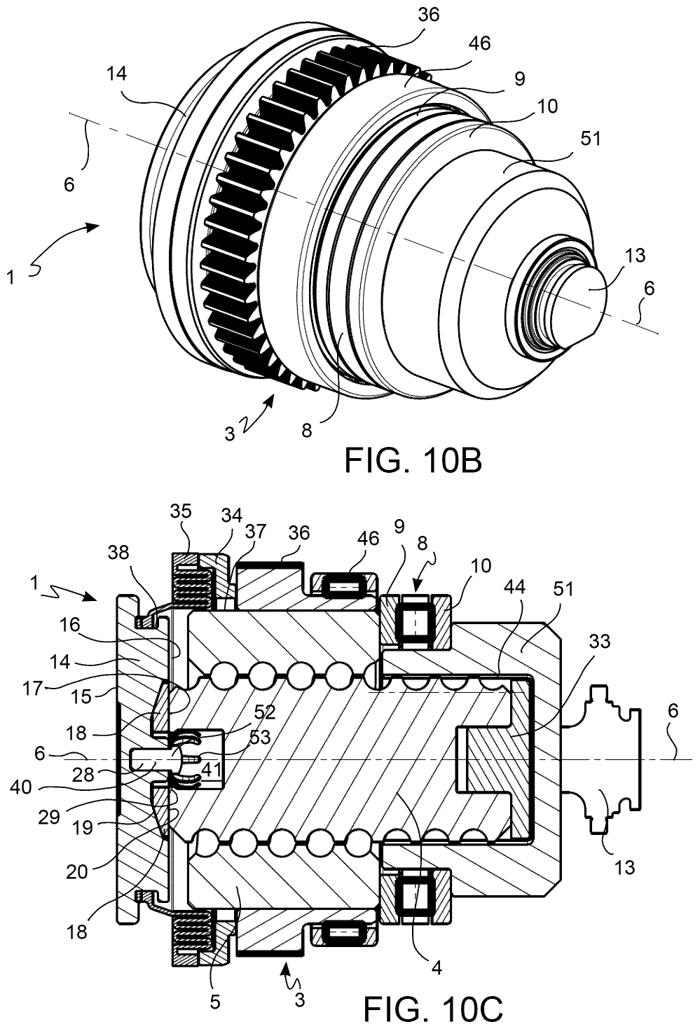

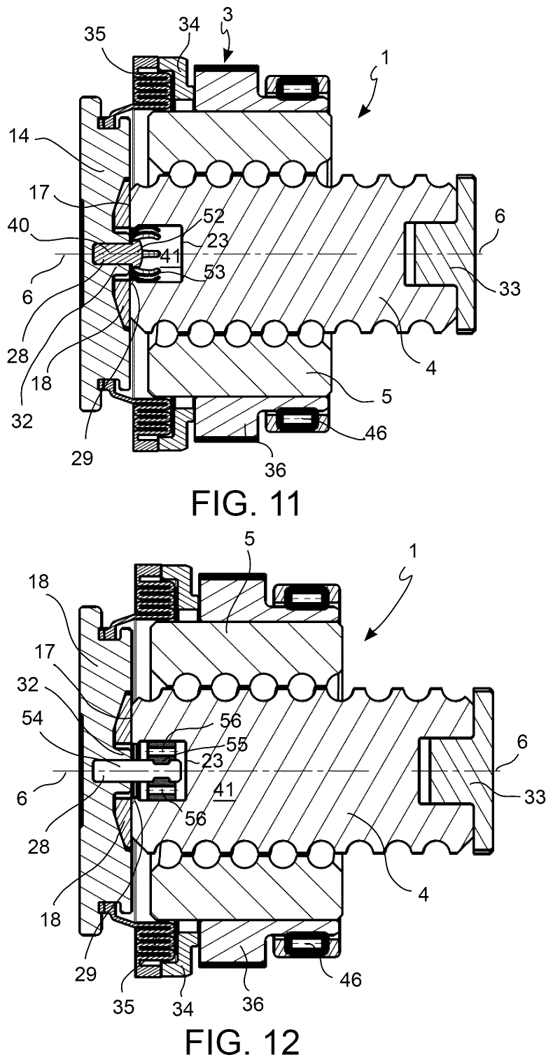

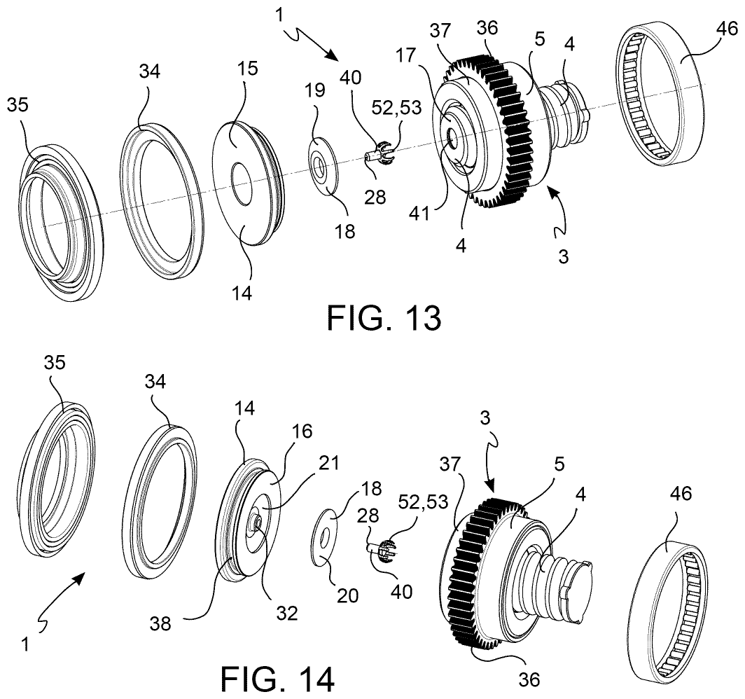

### DESCRIPTION OF SOME PREFERRED EMBODIMENTS

In the following description, the term “front” orientation refers to the orientation of sides, faces, surfaces, etc., in the forward (braking) direction of the threaded shaft, the term “rear” orientation refers to the orientation of sides, faces, surfaces, etc., in the retraction direction of the threaded shaft, unless otherwise specified. The terms “radial”, “circumferential”, “axial” should be intended with respect to the actuation axis of the threaded shaft unless otherwise specified. “Translation” and “rotation” with respect to the actuation axis or with respect to the axial direction means a translation or rotation with respect to an axis rotationally integral with the threaded shaft of the recirculating ball screw-nut screw assembly and translationally integral with the recirculating ball screw-nut screw assembly. “Axial direction” means a direction parallel to or coincident with the actuation axis.

With reference to the figures, the actuation device 1 for a disc brake 2 comprises a recirculating ball screw-nut screw assembly 3 and a thrust bearing 8.

The recirculating ball screw-nut screw assembly 3 comprises a threaded shaft 4 externally screwed onto the threaded shaft 4.

The threaded shaft 4 and the nut screw 5 extend in the direction of an actuation axis 6 coaxial to the threaded shaft 4.

The threaded shaft 4 extends between a front end thereof and a rear end thereof.

According to an aspect of the invention, the nut screw 5 is configured to receive a torque generatable by a gearmotor 7, and a rotation of the nut screw 5 with respect to the threaded shaft 4 results in a translation of the threaded shaft 4 with respect to the nut screw 5 in the direction of the actuation axis 6.

Moreover, the thrust bearing 8 forms a reaction rest for the nut screw 5 in the direction of the actuation axis 6.

Furthermore, the thrust bearing 8 is positioned within the extension of the threaded shaft 4 between said front end and said rear end of the threaded shaft 4.

Advantageously, an actuation device 1 so configured has small axial dimensions. Indeed, the application of the torque of the gearmotor 7 to the nut screw 5 avoids the system for transmitting such a torque from being located at the rear end of the threaded shaft 4, resulting in a reduction of the axial dimensions.

With added advantage, since the thrust bearing 8 is positioned within the axial extension of the threaded shaft 4 between said front end and said rear end of the threaded shaft 4, the axial dimensions of the threaded shaft 4 and the thrust bearing 8 are at least partially superimposed, resulting in a reduction of the axial dimension of the entire actuation device 1.

According to an embodiment of the invention, the threaded shaft 4 is positioned passing through the thrust bearing 8.

Advantageously, such a configuration eliminates the axial dimension of the thrust bearing 8, as it is completely included within the axial dimension of the threaded shaft 4.

According to an embodiment, the thrust bearing 8 comprises a first ring 9 and an opposite second ring 10.

In the operational configuration, the first ring 9 rotates with respect to the threaded shaft 4, while the second ring 10 does not rotate with respect to the threaded shaft 4.

According to an embodiment, the first ring 9 of the thrust bearing 8 is formed in one piece with the nut screw 5.

Advantageously, such a configuration further reduces the axial dimensions of the actuation device 1, since the dimension causable by the positioning of a specific rotating ring, opposite to the second ring 10, to be interposed between the nut screw 5 and the second ring 10, is avoided.

Specifically, the thrust bearing 8 comprises rolling members enclosed between two rolling tracks, a first rolling track 11 of which is defined by the first ring 9 and a second rolling track 12 of which is defined by the second ring 10.

According to this embodiment, the nut screw 5 defines the first rolling track 11.

Alternatively, the thrust bearing 8 is distinct from the nut screw 5. Therefore, the first ring 9 of the thrust bearing 8 is distinct from the nut screw 5 and is positioned to abut against the nut screw 5.

According to an embodiment, the thrust bearing 8 is a ball bearing. Alternatively, the thrust bearing 8 is a roller bearing.

According to an embodiment, the nut screw 5 forms an external toothing 36 configured to receive a torque from a gearmotor.

According to an embodiment, the actuation device 1 comprises a force sensor 13.

The force sensor 13 is configured to detect the braking force applied by the actuation device 1.

Specifically, the force sensor 13 is configured to detect the force applied in the axial direction by the actuation device 1.

According to an embodiment, the force sensor 13 is positioned at least partially superimposed, in an axial direction, on the threaded shaft 4.

Advantageously, such a configuration further reduces the axial dimensions of the actuation device 1 because the respective axial dimensions of the threaded shaft 4 and the force sensor 13 are at least partially superimposed.

According to a preferred embodiment, the force sensor 13 is substantially annular in shape. According to an embodiment, the threaded shaft 4 is positioned passing through the force sensor 13.

Advantageously, such a configuration eliminates the axial dimension of the force sensor 13, as it is completely superimposed on the axial dimension of the threaded shaft 4.

According to an embodiment, the force sensor 13 is positioned adjacent to the thrust bearing 8, in the opposite direction to the nut screw 5.

Specifically, the force sensor 13 is adjacent to the second ring 10 of the thrust bearing 8.

According to this embodiment, the force sensor 13 is configured to detect the reaction force acting on the thrust bearing 8.

Advantageously, by detecting the force acting on the thrust bearing 8, the force sensor 13 is capable of determining the braking force applied by the actuation device 1.

According to an alternative embodiment, the force sensor 13 is positioned behind the threaded shaft 4, at the rear end of the threaded shaft 4.

According to an embodiment, the force sensor 13 is substantially cylindrical, discoidal, or axisymmetric in shape.

According to an embodiment, the actuation device 1 comprises a spacer 51.

The spacer 51 is positioned to be coaxial to the threaded shaft 4, and is interposed between the force sensor 13 and the thrust bearing 8.

According to this embodiment, the spacer 51 is configured to discharge, onto the force sensor 13, the reaction force acting on the thrust bearing 8.

Advantageously, by detecting the force from the thrust bearing 8 and acting on the spacer 51, the force sensor 13 is capable of determining the braking force applied by the actuation device 1.

According to an embodiment, the spacer 51 is substantially cylindrical in shape.

According to an embodiment, the spacer 51 defines a housing groove, and the thrust bearing 8 is housed in the housing groove of the spacer 51.

According to an embodiment, the actuation device 1 comprises a thrust plate 14.

The thrust plate 14 is operatively connected to the front end of threaded shaft 4.

The thrust plate 14 is configured to receive a braking force from the threaded shaft 4.

The braking force is generated by a translation of the threaded shaft 4 induced by a rotation of the nut screw 5.

Furthermore, the thrust plate 14 is configured to discharge such a braking force onto a pad of the disc brake 2, so as to apply a braking force.

Preferably, the thrust plate 14 is made of steel. According to an alternative embodiment, the thrust plate 14 is made of aluminum or alloys thereof, or other light alloys.

According to an embodiment, the actuation device comprises a joint 18 interposed between the threaded shaft 4 and the thrust plate 14.

The joint 18 is configured to transfer force between the threaded shaft 4 and the thrust plate 14.

Moreover, the joint 18 is configured to allow and accommodate rotational and/or translational displacements of the thrust plate 14 with respect to the threaded shaft 4.

Advantageously, when the actuation device 1 is actuated to apply a braking force, the joint 18 allows the thrust plate 14 to be fully in contact with the pad of the disc brake 2 even when the caliper of the disc brake 2 deflects under the force implemented by actuation device 1.

With added advantage, the joint 18 avoids the generation of unbalanced loads acting on the recirculating ball screw-nut screw assembly 3, otherwise causable by the deformation of the caliper of the disc brake 2 under the action of braking force.

According to an embodiment, the thrust plate 14 forms a front plate wall 15 and a rear plate wall 16.

The front plate wall 15 faces the pad of the disc brake 2, and the rear plate wall 16 faces the threaded shaft 4.

The threaded shaft 4 forms a front shaft wall 17 facing the rear plate wall 16 of the thrust plate 14.

According to this embodiment, the joint 18 is interposed between the rear plate wall 16 and the front shaft wall 17.

According to an embodiment, the joint 18 forms a conical or truncated cone wall 19, abutting against the thrust plate 14, and an opposite planar wall 20, abutting against the threaded shaft 4.

According to an embodiment, the rear plate wall 16 defines a joint housing 21 in which the joint 18 is positioned.

According to an embodiment, the joint housing 21 defines a concave surface with respect to the joint 18.

According to a preferred embodiment, the joint housing 21 defines a ball-portion surface.

Advantageously, the geometric coupling between the conical or truncated cone wall 19 of the joint 18 and the ball-portion surface of the joint housing 21 reduces the radial load acting on the recirculating ball screw-nut screw assembly 3, and allows relative rotations and movements between the threaded shaft 4 and the thrust plate 14, and/or between the thrust plate 14 and the joint 18.

According to an embodiment, the front shaft wall 17 and the planar wall 20 of the joint 18 are made so that, when the actuation device 1 is actuated to apply a braking force, the static frictional force generated between the front shaft wall 17 and the planar wall 20 is lower than the static frictional force generated between the thrust plate 14 and the pad of the disc brake 2, or than the static frictional force generated between the thrust plate 14 and the conical or truncated cone wall 19 of the joint 18.

Advantageously, the low friction between the front shaft wall 17 and the planar wall 20 reduces the radial stresses acting on the recirculating ball screw-nut screw assembly 3.

Indeed, such a low friction causes the joint 18 to act as a decoupler between the threaded shaft 4 and the thrust plate 14 in case of radial load peaks due to the contact between the thrust plate 14 and the pad of the disc brake 2.

According to such a configuration, during the application of the braking force, the pad of the disc brake 2 cannot be supported by the threaded shaft 4, but is always supported by the caliper of the disc brake 2. Therefore, the tangential force applied by the brake disc to the pads is discharged onto the caliper of the disc brake 2, thus allowing the radial load acting on the front shaft wall 17 to be reduced.

According to an embodiment, the actuation device 1 comprises a radial bearing 46.

The radial bearing 46 is configured to sustain the radial stresses acting on the actuation device 1 and generated by the torque transmission from the gearmotor to the actuation device 1.

According to a preferred embodiment, the radial bearing 46 is externally connected to the nut screw 5.

Even more preferably, the radial bearing 46 is positioned to be adjacent to the thrust bearing 8, on the side facing the thrust plate 14.

Advantageously, such a configuration reduces the axial dimensions of the actuation device 1.

Preferably, the radial bearing 46 is a “roller” type bearing. Alternatively, the radial bearing 46 is a ball bearing.

According to an embodiment, the threaded shaft 4 is at least partially hollow in the axial direction, and forms an inner wall 23. The inner wall 23 defines a through cavity 24. Alternatively, the inner wall 23 defines an open blind cavity 41 at the front shaft wall 17.

According to an embodiment, the through cavity 24 extends between a front opening 25, defined at the front shaft wall 17, and a rear opening 26, defined at a rear shaft wall.

According to an embodiment, the inner wall 23 of the threaded shaft 4 forms a backing step 29.

According to an embodiment, the backing step 29 delimits a front cavity portion 30, extending between the backing step 29 and the front opening 25, and a rear cavity portion 31, extending between the backing step 29 and the rear opening 26.

The front cavity portion 30 has a smaller radial section than the radial section of the rear cavity portion 31.

According to an embodiment, the actuation device 1 comprises a retaining screw 22 configured to connect the threaded shaft 4 to the thrust plate 14 in the axial direction. Therefore, by means of the retaining screw 22, a retraction of the threaded shaft 4 corresponds to a retraction of the thrust plate 14. The retaining screw 22 thus ensures the detachment of the thrust plate 14 from the pad of the disc brake 2 so as to reduce any residual braking torque acting on the brake disc during the non-operation of the actuation device 1.

Moreover, the retaining screw 22 forms a screw head 27 and a threaded shank 28.

According to an embodiment, the screw head 27 is connected to the threaded shaft 4 and is positioned inside the through-cavity 24 and has an axial clearance with respect to the backing step 29, and the threaded shank 28 extends through the front cavity portion 30 and is connected to the thrust plate 14. Advantageously, the axial clearance of the screw head 27 with respect to the backing step 29 is such that the degrees of freedom granted by the joint 18 are preserved. The retaining screw 22 is configured to ensure that the retraction of the threaded shaft 4 also results in a retraction of the thrust plate 14.

According to an embodiment, the retaining screw 22 has an axial and radial clearance with respect to the inner wall 23 of the threaded shaft 4.

Advantageously, such a clearance is configured to allow rotational and/or translational displacements of the retaining screw 22, and thus of the thrust plate 14 screwed thereto, with respect to the threaded shaft 4.

This effect is particularly advantageous in case of complete adhesion of the thrust plate 14 to the pad of the disc brake 2 during the deformation of the caliper of the disc brake 2 under the action of the braking force.

According to an alternative embodiment, the actuation device 1 comprises a snap retaining connection 40 configured to connect the threaded shaft 4 to the thrust plate 14 in the axial direction.

The snap retaining connection 40 comprises a threaded shank 28 and a snap connection head 52.

The threaded shank 28 is connected to the thrust plate 14, and the snap connection head 52 is snap-connected to the threaded shaft 4.

According to an embodiment, the snap retaining connection 40 is configured to be insertable into the blind cavity 41 by means of a snap connection, such that it resists an extraction force from the blind cavity 41.

According to an embodiment, the snap connection head 52 is positioned inside the blind cavity 41. The threaded shank 28 extends through the blind cavity 41, exits from the front shaft wall 17, and is connected to the thrust plate 14.

The snap retaining connection 40 is configured to ensure that the retraction of the threaded shaft 4 results in the retraction of the thrust plate 14. Therefore, by means of the snap retaining connection 40, a retraction of the threaded shaft 4 corresponds to a retraction of the thrust plate 14. The snap retaining connection 40 thus ensures the detachment of the thrust plate 14 from the pad of the disc brake 2, so as to reduce any residual braking torque acting on the brake disc during the non-operation of the actuation device 1.

According to a preferred embodiment, the snap connection head 52 comprises a plurality of petals 53 at least partially extending in a radial direction with respect to the shank 28.

The petals 53 are configured to be elastically biased as they approach the axis of the threaded shank 28. The snap connection head 52 and petals 53 can thus be inserted into the blind cavity 41. Specifically, they are insertable beyond the backing step 29.

Upon the successful insertion into the blind cavity 41, the petals 53 are configured to extend away from the axis of the threaded shank 28, so as to make a snap connection with the threaded shaft 4. Specifically, the petals 53 release their elastic potential, extending again in an at least partially radial direction with respect to the threaded shank 28, as they pass the backing step 29.

Advantageously, such a configuration of the snap retaining connection 40 accommodates any rotational and/or translational displacements of the snap retaining connection 40, and thus of the thrust plate 14 screwed thereto, with respect to the threaded shaft 4.

According to another alternative embodiment, the actuation device 1 comprises a retaining pin 54, configured to connect the threaded shaft 4 to the thrust plate 14 in the axial direction.

The retaining pin 54 comprises a threaded shank 28 and a pin head 55.

According to an embodiment, the pin head 55 is coated with a polymer material. Preferably, the pin head 55 is coated with a rubber overmolding.

According to an embodiment, the pin head 55 defines at least one vent hole 56 passing through the pin head 55 in a direction parallel to the threaded shank 28.

Preferably, the pin head 55 defines a plurality of vent holes 56.

Advantageously, by means of the vent holes 56, the pin head 55 coated with a polymer material acts as a suction cup. Therefore, the retaining pin 54, by means of the pin head 55 thus configured, is connectable to the threaded shaft 4 by means of a “suction-cap” effect, i.e., by vacuum adhesion.

Advantageously, such a configuration of the retaining pin 54 accommodates any rotational and/or translational displacements of the retaining pin 54, and thus of the thrust plate 14 screwed thereto, with respect to the threaded shaft 4.

According to an embodiment, the pin head 55 is positioned inside the blind cavity 41. The threaded shank 28 extends through the blind cavity 41, exits from the front shaft wall 17, and is connected to the thrust plate 14. According to this configuration, the pin head 55 adheres with a suction-cup effect to the inner wall 23 defining the blind cavity 41.

The retaining pin 54 is configured to ensure that the retraction of the threaded shaft 4 results in the retraction of the thrust plate 14. Therefore, by means of the retaining pin 54, a retraction of the threaded shaft 4 corresponds to a retraction of the thrust plate 14. The retaining pin connection 54 thus ensures the detachment of the thrust plate 14 from the pad of the disc brake 2, so as to reduce any residual braking torque acting on the brake disc during the non-operation of the actuation device 1.

According to an embodiment, the rear plate wall 16 forms a nut screw portion 32 extending axially in the direction of the threaded shaft 4.

According to this embodiment, the threaded shank 28 is screwed to the nut screw portion 32 of the thrust plate 14.

Specifically, the threaded shank 28 of the retaining screw 22, or the threaded shank 28 of the snap retaining connection 40, or the threaded shank 28 of the retaining pin 28 is screwed to the nut screw portion 32 of the thrust plate 14.

According to a preferred embodiment, the nut screw portion 32 extends through the front opening 25 of the threaded shaft 4, into the front cavity portion 30.

According to an embodiment, the joint 18 defines a through-hole extending between the conical or truncated cone wall 19 and the planar wall 20, and the nut screw 32 portion of the thrust plate 14 extends through such a through-hole.

According to an embodiment, the actuation device 1 comprises a plug 33 positioned inside the inner wall 23 of the threaded shaft 4.

The plug 33 is configured to seal a through cavity 24 defined by the inner wall 23.

Advantageously, the plug 33 prevents the ingress of dust, moisture, liquids, or external contaminants that would deteriorate the components of the actuation device 1 located at the rear shaft wall, passing through the clearance between the retaining screw 22 and the inner wall 23 of the threaded shaft 4, or between the snap retaining connection 40 and the inner wall, 23 or the retaining pin 54 and the inner wall 23.

According to a preferred embodiment, the plug 33 is positioned inside the rear cavity portion 31 of the through-hole 24.

According to an embodiment, the plug 33 is positioned behind the threaded shaft 4, at the rear wall of the threaded shaft 4, inside the bushing 44, and is configured to seal the rear wall of the threaded shaft 4.

Advantageously, the plug 33 prevents the ingress of dust, moisture, liquids, or external contaminants that would deteriorate the components of the actuation device 1 located at the rear shaft wall, passing through the clearance between the retaining screw 22 and the inner wall 23 of the threaded shaft 4, or between the snap retaining connection 40 and the inner wall, 23 or the retaining pin 54 and the inner wall 23.

According to an embodiment, the actuation device 1 comprises a dynamic seal positioned outside the nut screw 5 at the thrust plate 14.

The dynamic seal is configured to achieve a fluid seal between the nut screw 5 and the thrust plate 14.

According to another preferred embodiment, the dynamic seal is a “lip” type seal.

According to an embodiment, the actuation device 1 comprises a static seal 35 connected to the thrust plate 14 and extending radially outwards from the thrust plate 14.

The static seal 35 is configured to achieve a fluid seal between the actuation device 1 and a pad of the disc brake 2.

Advantageously, the static seal 35 protects the mechanical components of the actuation device 1 from contact with dust, moisture or other contaminants.

According to an embodiment, the nut screw 5 defines a circumferential housing 37. The circumferential housing 37 is interposed between the outer toothing 36 and the thrust plate 14.

The static seal 35 is positioned in the circumferential housing 37.

According to an embodiment, the thrust plate 14 defines a circumferential groove 38 extending inwards from the thrust plate 14 in the radial direction.

According to this embodiment, the static seal 35 is positioned in the circumferential housing 37, and one end of the static seal 35 is inserted into the circumferential groove 38.

According to another preferred embodiment, the static seal 35 is a seal of the “bellows” type.

According to an embodiment, the actuation device 1 comprises a lock ring 34.

The lock ring 34 is located outside the nut screw 5. The lock ring 34 is interposed with contact between the static seal 35 and the outer toothing 36 of the nut screw 5.

The lock ring 34 is configured to hold the actuation device 1 in the predetermined position inside the caliper of the disc brake 2.

According to an embodiment, one end of the lock ring 34 is positioned abutting against the outer toothing 36. Advantageously, such an end abutting against the outer toothing 36 prevents any disassembly of the actuation device 1 due to the vibrations generatable during the operation of the actuation device 1.

According to a preferred embodiment, the lock ring 34 has an “S”- or “Z”-shaped profile along an axial section parallel to the actuation axis 6. According to this embodiment, one end of the lock ring 34 abuts against the static seal 35 and an opposite end of the lock ring abuts against the outer toothing 36.

According to an embodiment, the actuation device 1 comprises anti-rotation means 39.

The anti-rotation means 39 are configured to allow a translation of the threaded shaft 4 in the axial direction and to prevent a rotation of the threaded shaft 4 about the axial direction.

Therefore, the anti-rotation means 39 are configured to prevent the rotation of the nut screw 5 from rotating the threaded shaft 4.

According to an embodiment, the anti-rotation means 39 comprise an anti-rotation pin 43 engaged on the threaded shaft 4.

According to an embodiment, the anti-rotation means 39 further comprise a bushing 44. The bushing 44 is connected to the caliper of the disc brake 2 by interference coupling.

The bushing 44 is connected to threaded shaft 4. Specifically, the bushing 44 is connected to the threaded shaft 4 at the rear wall of the threaded shaft 4.

The bushing 44 defines a bushing slot 45 passing radially and extending in the axial direction.

According to this embodiment, the anti-rotation pin 43 is engaged on the threaded shaft 4, and passes through the bushing slot 45.

According to an embodiment, the bushing 44 is made of aluminum.

According to an embodiment, the thrust bearing 8 and/or the force sensor 13 are connected to the bushing 44.

Preferably, the bushing 44 is positioned externally about the threaded shaft 4 at the rear end of the threaded shaft 4.

According to an embodiment, the recirculating ball screw-nut screw assembly 3, the retaining screw 22 and anti-rotation pin 43 are made of steel.

According to a further aspect of the invention, the disc brake 2 comprises a caliper 47 comprising side walls mutually two spaced apart and delimiting a disc space to accommodate a brake disc portion 49, means for fixing the caliper to a vehicle, a connecting structure which extends straddling the disc space and connects the side walls to each other, at least one pad housing formed in each of said side walls and adapted to accommodate at least one pad 48, thrust means constrained to one or both side walls and adapted to bias the pads 48 against the brake disc 49 to clamp it, where the thrust means comprise the actuation device 1 as described above.

Moreover, the disc brake 2 comprises a gearmotor 7 and a transmission system 50 configured to transmit mechanical power generated by the gearmotor 7 to the nut screw 5 of the actuation device 1.

According to an embodiment, the transmission system 50 comprises a gear meshed with the outer toothing 36 of the nut screw 5.

Obviously, those skilled in the art will be able to make changes or adaptations to the present invention, without however departing from the scope of the following claims.

### LIST OF REFERENCE NUMERALS

1. Actuation device
2. Disc brake
3. Recirculating ball screw-nut screw assembly
4. Threaded shaft
5. Nut screw
6. Actuation axis
7. Gearmotor
8. Thrust bearing
9. First ring
10. Second ring
11. First rolling track
12. Second rolling track
13. Force sensor
14. Thrust plate
15. Front plate wall
16. Rear plate wall
17. Front shaft wall
18. Joint
19. Conical or truncated cone wall
20. Planar wall
21. Joint housing
22. Retaining screw
23. Inner wall
24. Through cavity
25. Front opening
26. Rear opening
27. Screw head
28. Threaded shank
29. Backing step
30. Front cavity portion
31. Rear cavity portion
32. Nut screw portion
33. Plug
34. Lock ring
35. Static seal
36. External toothing
37. Circumferential housing
38. Circumferential groove
39. Anti-rotation means
40. Snap retaining connection
41. Blind cavity
43. Anti-rotation pin
44. Bushing
45. Bushing slot
46. Radial bearing
47. Caliper
48. Pads
49. Brake disc
50. Transmission system
51. Spacer
52. Snap connection head
53. Petals
54. Retaining pin
55. Pin head
56. Vent holes

1-27. (canceled)

28. An actuating device for a brake disc, comprising:
a recirculating ball screw-nut screw assembly, and
a thrust bearing,
wherein the recirculating ball screw-nut screw assembly comprises a threaded shaft and a nut screw externally screwed onto the threaded shaft,
wherein the threaded shaft and the nut screw extend in a direction of an actuation axis coaxial to the threaded shaft, wherein the threaded shaft extends between a front end of the threaded shaft and a rear end of the threaded shaft, and wherein
the nut screw is configured to receive a torque generatable by a gearmotor, and a rotation of the nut screw relative to the threaded shaft results in a translation of the threaded shaft relative to the nut screw in the direction of the actuation axis,
the thrust bearing provides a reaction rest for the nut screw in the direction of the actuation axis, and
the thrust bearing is positioned within an extension of the threaded shaft between said front end and said rear end of the threaded shaft.

29. The actuation device of claim 28, wherein the threaded shaft is positioned passing through the thrust bearing.

30. The actuation device of claim 28, wherein the thrust bearing comprises a first ring and an opposite second ring,
wherein, in an operational configuration, the first ring rotates relative to the threaded shaft while the second ring does not rotate relative to the threaded shaft, and
wherein the first ring of the thrust bearing is formed in one piece with the nut screw.

31. The actuation device of claim 28, further comprising a force sensor configured to detect a force actuated by the actuation device in an axial direction, wherein the force sensor is positioned at least partially superimposed, in the axial direction, on the threaded shaft.

32. The actuation device of claim 31, wherein the force sensor has a substantially annular shape, and wherein the threaded shaft is positioned passing through the force sensor.

33. The actuation device of claim 31, wherein the force sensor is positioned adjacent to the thrust bearing, in a direction opposite to the nut screw, and wherein the force sensor is configured to detect a reaction force acting on the thrust bearing.

34. The actuation device of claim 28, further comprising a force sensor configured to detect a force actuated by the actuation device in an axial direction, wherein the force sensor is positioned behind the threaded shaft, at the rear end of the threaded shaft, and wherein, optionally, the force sensor has a cylindrical, discoidal, or axisymmetric shape.

35. The actuation device of claim 34, further comprising a spacer positioned coaxially to the threaded shaft and interposed between the force sensor and the thrust bearing, wherein the spacer is configured to discharge a reaction force acting on the thrust bearing onto the force sensor, and wherein, optionally, the spacer defines a housing groove, and the thrust bearing is housed within the housing groove of the spacer.

36. The actuation device of claim 28, further comprising a thrust plate operatively connected to the front end of the threaded shaft,
said thrust plate being configured to receive a braking force from the threaded shaft generated by a translation of the threaded shaft induced by a rotation of the nut screw,
said thrust plate being further configured to discharge said braking force onto a disc brake pad, to actuate the braking force,
wherein, optionally, the thrust plate is made of steel.

37. The actuation device of claim 36, further comprising a joint interposed between the threaded shaft and the thrust plate, said joint being configured to:
transfer force between the threaded shaft and the thrust plate; and
allow and accommodate rotational and/or translational displacements of the thrust plate relative to the threaded shaft.

38. The actuation device of claim 37, wherein the thrust plate forms a front plate wall and a rear plate wall,
wherein the front plate wall faces the disc brake pad, and the rear plate wall faces the threaded shaft,
wherein the threaded shaft forms a front shaft wall facing towards the rear plate wall of the thrust plate, and
wherein the joint is interposed between the rear plate wall and the front shaft wall, and
wherein the joint forms a conical or truncated cone wall abutting against the thrust plate, and an opposite planar wall abutting against the threaded shaft.

39. The actuation device of claim 38, wherein the rear plate wall defines a joint housing in which the joint is positioned, wherein the joint housing defines a concave surface relative to the joint, and, optionally, the joint housing defines a ball-portion-shaped surface.

40. The actuation device of claim 38, wherein the front shaft wall and the planar wall of the joint are made so that, when the actuation device is actuated to actuate the braking force, a static frictional force generated between the front shaft wall and the planar wall is less than a static frictional force generated between the thrust plate and the disc brake pad, or than a static frictional force generated between the thrust plate and the conical or truncated cone wall of the joint.

41. The actuation device of claim 28, further comprising a radial bearing configured to support radial stresses acting on the actuation device and generated by a torque transmission from the gearmotor to the actuation device,
wherein, optionally, the radial bearing is externally connected to the nut screw, and/or
wherein the radial bearing is positioned adjacent to the thrust bearing.

42. The actuation device of claim 36, further comprising a retaining screw configured to connect the threaded shaft to the thrust plate in an axial direction, such that a retraction of the threaded shaft corresponds to a retraction of the thrust plate.

43. The actuation device of claim 42, wherein the threaded shaft is at least partially hollow in the axial direction, and forms an inner wall, wherein the inner wall defines a through-cavity extended between a front opening, defined at the front shaft wall, and a rear opening, defined at a rear shaft wall,
wherein the inner wall forms a backing step that delimits a front cavity portion, extending between the backing step and the front opening, and a rear cavity portion, extending between the backing step and the rear opening, wherein a radial cross-section of the front cavity portion is smaller than a radial cross-section of the rear cavity portion,
wherein the retaining screw forms a screw head and a threaded shank, and
wherein the screw head is connected to the threaded shaft and positioned within the through-cavity and has axial clearance relative to the backing step, and the threaded shank extends through the front cavity portion and is connected to the thrust plate.

44. The actuation device of claim 36, further comprising a snap retaining connection configured to connect the threaded shaft to the thrust plate in an axial direction, wherein the snap retaining connection comprises a threaded shank and a snap connection head, and wherein the threaded shank is connected to the thrust plate, and the snap connection head is snap-connected to the threaded shaft.

45. The actuation device of claim 44, wherein the threaded shaft is at least partially hollow in the axial direction, and forms an inner wall, wherein the inner wall defines a blind cavity open at the front shaft wall,
wherein the inner wall forms a backing step,
wherein the snap retaining connection is configured to be insertable into the blind cavity through snap connection, such that the snap retaining connection resists a pull-out force from the blind cavity,
wherein the snap connection head is positioned inside the blind cavity, wherein the threaded shank extends through the blind cavity, leads out of the front shaft wall, and is connected to the thrust plate,
wherein the snap connection head comprises a plurality of petals extending at least partially in a radial direction relative to the threaded shank, said petals being configured to be elastically biased as the petals approach an axis of the threaded shank such that the snap connection head and the petals are insertable within the blind cavity, beyond the backing step, and
wherein, upon a successful insertion into the blind cavity, the petals are configured to extend away from the axis of the threaded shank to make a snap connection with the threaded shaft.

46. The actuation device of claim 36, further comprising a retaining pin configured to connect the threaded shaft to the thrust plate in an axial direction, wherein the retaining pin comprises a threaded shank and a pin head,
wherein the pin head is coated with a polymeric material, and defines at least one vent hole passing through the pin head in a direction parallel to the threaded shank, and
wherein the retaining pin, by the pin head, is connectable to the threaded shaft by vacuum adhesion.

47. The actuation device of claim 46, wherein the threaded shaft is at least partially hollow in the axial direction, and forms an inner wall, wherein the inner wall defines a blind cavity open at the front shaft wall,
wherein the inner wall forms a backing step,
wherein the pin head is positioned within the blind cavity,
wherein the threaded shank extends through the blind cavity, exits from the front shaft wall, and is connected to the thrust plate, and wherein the pin head adheres with a suction effect to the inner wall defining the blind cavity.

48. The actuation device of claim 43, wherein the rear plate wall forms a nut screw portion extending axially in a direction of the threaded shaft, and wherein the threaded shank is screwed to the nut screw portion of the thrust plate.

49. The actuation device of claim 28, further comprising a plug positioned within an inner wall of the threaded shaft,
wherein the plug is configured to seal a through cavity defined by the inner wall, or
wherein the plug is positioned posterior to the threaded shaft, at a rear shaft wall, inside a bushing, and is configured to seal the rear shaft wall.

50. The actuation device of claim 36, further comprising a static seal connected to the thrust plate and extending radially outwardly from the thrust plate,
said static seal being configured to make a fluid seal between the actuating device and a disc brake pad,
wherein, optionally, the nut screw defines a circumferential housing and the thrust plate defines a circumferential groove extending inwardly from the thrust plate in a radial direction, and wherein the static seal is positioned in the circumferential housing and one end of the static seal is inserted within the circumferential groove, and/or
wherein the static seal is a bellows seal.

51. The actuation device of claim 50, further comprising a lock ring positioned externally to the nut screw, wherein the lock ring is interposed with contact between the static seal and an external toothing of the nut screw, wherein the lock ring is configured to retain the actuation device in a predetermined position within a disc brake caliper, and wherein, optionally, the lock ring has an “S” or “Z” profile along an axial section parallel to the actuation axis, and one end of the lock ring abuts against the static seal and an opposite end of the lock ring abuts against the external toothing.

52. The actuation device of claim 28, further comprising anti-rotation means configured to allow a translation of the threaded shaft in an axial direction and to prevent a rotation of the threaded shaft about the axial direction.

53. The actuation device of claim 52, wherein the anti-rotation means comprise an anti-rotation pin engaged on the threaded shaft, and a bushing connected to the threaded shaft, optionally by interference coupling,
wherein the bushing defines a bushing slot passing radially and extending in the axial direction,
wherein the anti-rotation pin is coupled on the threaded shaft and passed through the bushing slot, and
wherein, optionally, the bushing is made of aluminum, and/or
wherein the thrust bearing and/or a force sensor are connected to the bushing.

54. A disc brake, comprising a caliper comprising two mutually spaced apart side walls which delimit a disc space to accommodate a portion of a brake disc, means for fixing the caliper to a vehicle, a connecting structure which extends straddling the disc space and connects the side walls to each other, at least one pad housing formed in each of said side walls and adapted to accommodate at least one pad, thrust means constrained to one or both side walls and adapted to bias the at least one pad against the brake disc to clamp the brake disc, wherein the thrust means comprise the actuating device of claim 28, and optionally, the disc brake comprises a gearmotor and a transmission system configured to transmit a mechanical power generated by the gearmotor to the nut screw of the actuation device, and the transmission system comprises a gear meshing with an external toothing of the nut screw.
